(19) United States
(12) Patent Application Publication
(10) Pub. No.: US 2017/0075098 A1
(43) Pub. Date: Mar. 16, 2017

(54) MICROSCOPE LENS AND MICROSCOPE SYSTEM INCLUDING THE SAME

(71) Applicants: BOE TECHNOLOGY GROUP CO., LTD., Beijing (CN); HEFEI BOE OPTOELECTRONICS TECHNOLOGY CO., LTD., Hefei, Anhui (CN)

(72) Inventors: Xingkui Guo, Beijing (CN); Haitao Wang, Beijing (CN); Jiangang Zhai, Beijing (CN)

(21) Appl. No.: 15/122,236

(22) PCT Filed: Aug. 10, 2015
(86) PCT No.: PCT/CN2015/086506

§ 371 Date: Aug. 29, 2016

(30) Foreign Application Priority Data
Apr. 24, 2015 (CN) 201510203492.9

(51) Int. Cl. G02B 21/24; F21V 8/00; G02B 21/26; G02B 21/04; G02B 21/08

(52) U.S. Cl. CPC G02B 21/248; G02B 21/04; G02B 21/084; G02B 21/26; G02B 6/0008

(57) ABSTRACT

Embodiments of the invention provide a microscope lens, which comprises an eye lens end and an objective lens end, wherein a central axis of the eye lens end intersects a central axis of the objective lens end, and the microscope lens further comprises a reflector disposed between the eye lens end and the objective lens end, such that light from one of the eye lens end and the objective lens end is reflected by the reflector before exiting from the other of the eye lens end and the objective lens end. Embodiments of the invention also provide a microscope system comprising the above microscope lens. With the microscope lens and the microscope system provided in this disclosure, observation and identification of the defect(s) on the observed object (for example, a glass substrate) may be improved, and accuracy of statistic of product yield can thereby be increased.

### TECHNICAL FIELD

The present disclosure relates to the field of optical microscopy, and specifically, to a microscope lens adapted for omnidirectional analysis and observation on defect(s) of an observed object during a maintenance process of an array substrate in the field of TFT-LCD, and a microscope system that includes the microscope lens.

### BACKGROUND

In the field of TFT-LCD, a microscope system in a prior maintenance apparatus for array substrates is typically used to analyze and observe planar image information (for example, a defect) of an observed object. Specifically, referring to FIG. 1, in a microscope system in prior art, incident light L1 is perpendicular to an object stage 1 and is transmitted via a lens 2 to a surface of an observed object 3, while reflected light L2 is reflected back from the surface of the observed object 3 and passes through the microscope lens 2 again and goes into a camera (not shown), and image information of the surface of the observed object 3 is shown on a display via a photoelectric converting component. However, with the above analysis and observation system and method, only a planar image information of the observed object (for example, a glass substrate) may be obtained, other information such as its height, profile and the like cannot be obtained, thus, defect(s) of the observed object cannot be clearly and comprehensively identified, and a wrong judgment or an overestimation may occur, causing an adverse influence on accurate statistic of product yield. Moreover, a significantly adverse influence on subsequent process and apparatus thereof may occur.

Therefore, an improved microscope lens and a microscope system including such microscope lens are needed.

### SUMMARY

The present invention has been made to overcome or alleviate at least one aspect of the above mentioned disadvantages.

Thus, at least one object of the present invention is to provide a microscope lens, which may improve observation and identification of the defect(s) on the observed object (for example, a glass substrate), and accuracy of statistic of product yield can thereby be increased.

Another object of the present invention is to provide a microscope system, which may improve observation and identification of the defect(s) on the observed object (for example, a glass substrate), and accuracy of statistic of product yield can be thereby increased.

According to an aspect of the present invention, there is provided a microscope lens, which comprises an eye lens end and an objective lens end, wherein a central axis of the eye lens end intersects a central axis of the objective lens end; and the microscope lens further comprises a reflector disposed between the eye lens end and the objective lens end, such that light from one of the eye lens end and the objective lens end is reflected by the reflector before exiting from the other of the eye lens end and the objective lens end.

According to an exemplary embodiment, an inclination angle of the reflector relative to the central axis of the eye lens end is configured to be a half of an included angle between the central axis of the objective lens end and the central axis of the eye lens end.

According to an exemplary embodiment, the reflector is formed separately from the eye lens end and the objective lens end, or the reflector is formed integrally with the eye lens end and/or the objective lens end.

According to an exemplary embodiment, the microscope lens further comprises a light source disposed inside the microscope lens, the light source being disposed in an annular configuration along an inner circumference of the objective lens end.

According to an exemplary embodiment, the light source comprises a LED light source provided with a power source.

According to an exemplary embodiment, the power source comprises a sheet shaped battery and/or an annular shaped battery.

According to an exemplary embodiment, the microscope lens further comprises an optic fiber for introducing illumination light from an external light source into the microscope lens.

According to another aspect of the present invention, there is provided a microscope system, which comprises: an object stage configured for supporting an observed object; the microscope lens as described above, configured for observing the observed object supported on the object stage; and a rotation mechanism for the microscope lens, the rotation mechanism being configured for implementing a 360 degree rotation movement of the microscope lens relative to the observed object to realize a 360 degree omnidirectional observation on the observed object.

According to an exemplary embodiment, the rotation mechanism comprises an annular rail on which the microscope lens is movably disposed.

According to an exemplary embodiment, the microscope lens is disposed on the annular rail via a gear mechanism.

According to an exemplary embodiment, the rotation mechanism further comprises a driving motor configured for driving the microscope lens.

According to a further aspect of the present invention, there is provided a microscope system, which comprises: an object stage configured for supporting an observed object; the microscope lens as described above, configured for observing the observed object supported on the object stage; a driving mechanism for rotation movement of the microscope lens, the driving mechanism being configured to rotate the microscope lens about an central axis of the eye lens end of the microscope lens; and a conveying mechanism disposed on the object stage and configured to move the observed object following the rotation movement of the microscope lens.

According to an exemplary embodiment, the driving mechanism for rotation movement of the microscope lens further comprises a driving motor configured for driving the microscope lens to rotate.

From the above, with the microscope lens and the microscope system provided in the present disclosure, at least the following technical effects may be achieved: first, a reflector oriented at a certain angle is provided inside the microscope lens to change the light path so as to realize a microscopic stereoscopic observation at the certain angle; second, by providing the light source inside the microscope lens, intensity of light may be increased; third, by providing the rotation mechanism for the microscope lens in the microscope system, a 360 degree omnidirectional observation on an observed object may be realized. Therefore, with the microscope lens and the microscope system provided in the present disclosure, observation and identification of defect(s) on an observed object (for example a glass substrate) can be improved, accuracy of statistic of product yield can be increased, and a significantly adverse influence on subsequent process and apparatus thereof can be avoided.

### BRIEF DESCRIPTION OF THE DRAWINGS

In order to make the above and other features, characteristics and advantages of the present disclosure become more apparent, exemplary embodiments of the present disclosure will be described with reference to the accompanying drawings, in which:

FIG. 1 is a schematic view showing operating principle and structure of a conventional microscope system;

FIG. 2 is a schematic view showing operating principle and structure of a microscope system according to a specific embodiment of the present disclosure;

FIG. 3 is a schematic view showing operating principle and structure of a microscope system according to another specific embodiment of the present disclosure;

FIG. 4 is a schematic view showing operating principle and structure of a microscope system according to a further specific embodiment of the present disclosure;

FIG. 5 is a schematic view showing a moving trajectory of a microscope lens according to a specific embodiment of the present disclosure; and

FIG. 6 is a schematic view showing a moving trajectory of a microscope lens according to another specific embodiment of the present disclosure;

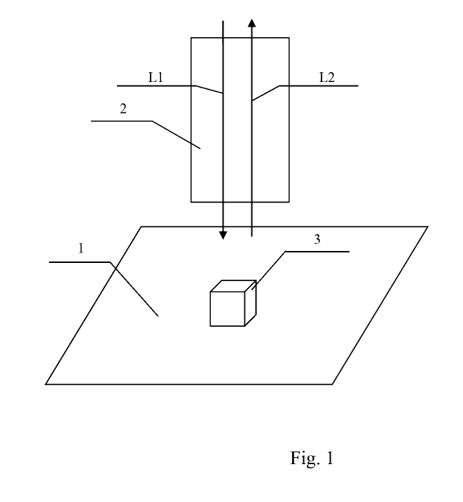

### DETAILED DESCRIPTION OF PREFERRED EMBODIMENTS

Exemplary embodiments of the present disclosure will be described hereinafter in detail with reference to the attached drawings, wherein the like reference numerals refer to the like elements. The embodiments described in conjunction with the attached drawings should not be construed as a limitation of the disclosure; rather, these embodiments are exemplary and are provided to explain the concept of the disclosure.

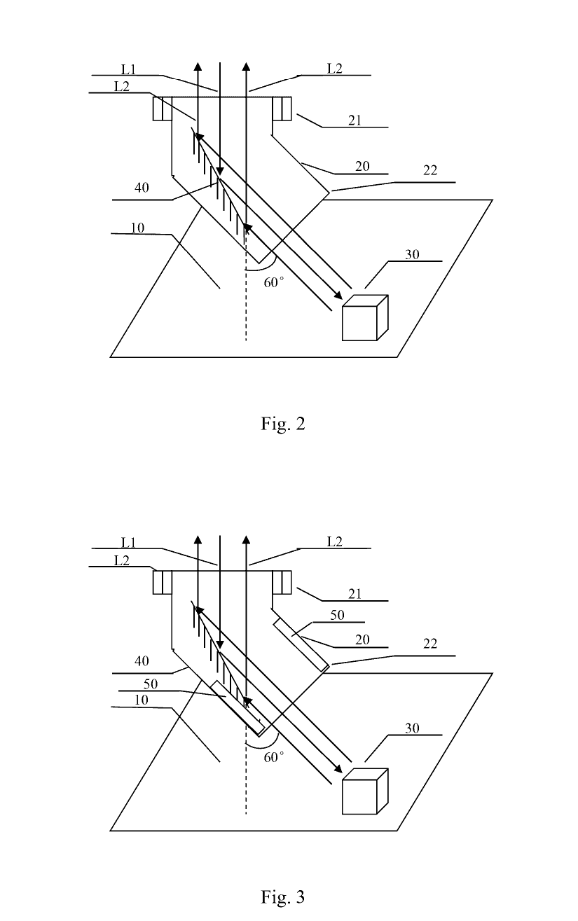

First, the present disclosure provides a microscope lens, which may be used in prior art microscope systems or may be used in the microscope system provided in this disclosure (shown in FIGS. 2-4 and will be described in detail hereinafter), to omnidirectionally analyze and observe defect(s) of an observed object (such as a glass substrate) during a maintenance process of an array substrate in the field of TFT-LCD.

The microscope system shown in FIG. 2 is taken as an example. The present disclosure provides a microscope lens 20, which includes an eye lens end 21 and an objective lens end 22, and a central axis of the eye lens end 21 intersects a central axis of the objective lens end 22. The microscope lens 20 further includes a reflector 40 disposed between the eye lens end 21 and the objective lens end 22, such that incident light L1 and/or exiting light L2 between the eye lens end 21 and the objective lens end 22 are reflected before entering and/or exiting. In other words, in the microscope lens 20 provided in the present disclosure, the eye lens end 21 and the objective lens end 22 are disposed at an angle with respect to each other, instead of being disposed in line in prior art. Moreover, a reflector 40 oriented at a certain angle is disposed in the microscope lens 20. In such a manner, reflected light L2 may be reflected back in a predetermined path and intensity of the reflected light is increased. Ideally, the reflector 40 is disposed such that the reflected light from an observed object 30 exits the eye lens vertically to facilitate observation. Thus, a predetermined angle of a reflecting surface of the reflector 40 relative to a horizontal plane or a vertical direction depends on a height difference and a horizontal distance between the reflector 40 and the observed object 30. It can be designed and determined according to practical situation. Specifically, an inclination angle of the reflector 40 relative to the central axis of the eye lens end 21 is configured to be a half of an included angle between the reflected light L2 from the observed object 30 and the central axis of the eye lens end 21, or it is configured to be a half of an included angle between the central axis of the objective lens end and the central axis of the eye lens end (assuming that the light is transmitted along the central axis of the objective lens end and the central axis of the eye lens end). For example, in the specific embodiment shown in FIG. 2, when an included angle between a direction of the reflected light L2 from the observed object 30 and the central axis of the eye lens end 21 is 60 degrees, an inclination angle of the reflector 40 relative to the central axis of the eye lens end 21 is 30 degrees, such that the light L1 is ensured to exit from the eye lens end 21 vertically. In another embodiment, for example, if the included angle between the direction of the reflected light L2 and the central axis of the eye lens end 21 is 45 degrees, the inclination angle of the reflector 40 relative to the central axis of the eye lens end 21 is 22.5 degrees. Therefore, with the microscope lens provided in this disclosure, defect(s) of the observed object (such as a glass substrate) can be clearly and omnidirectionally analyzed and observed, so that the observation and identification of the defect(s) on the observed object can be improved, accuracy of statistic of product yield can be increased, and a significantly adverse influence on subsequent process and apparatus thereof can be avoided.

In the above embodiment, the reflector 40 is a planar reflector. Or else, it may be a reflector of any type that can provide an expected performance of observation.

According to the embodiment of the present disclosure shown in FIG. 2, the reflector 40 may be formed integrally with the eye lens end 21 and/or the objective lens end 22 of the microscope lens 20. Such a design may optimally save space for the microscope lens and simplify its structure, such that the microscope lens 20 incorporated with the reflector 40 may be provided as a whole in the microscope system provided by this disclosure or in other similar occasions, thus, it can be used much more simply and widely. Optionally, in another embodiment of the present disclosure, the reflector may be independent from the eye lens end and the objective lens end of the microscope lens, such that the reflector may be positioned or adjusted (for example, adjustment of an angle at which the reflector is mounted) as required, and the included angle between the eye lens end and the objective lens end may be correspondingly adjusted. In such a design, the reflector may be handled flexibly and the microscope lens may be used with or without the reflector, such that the cost for using the microscope lens may be reduced to a certain extent.

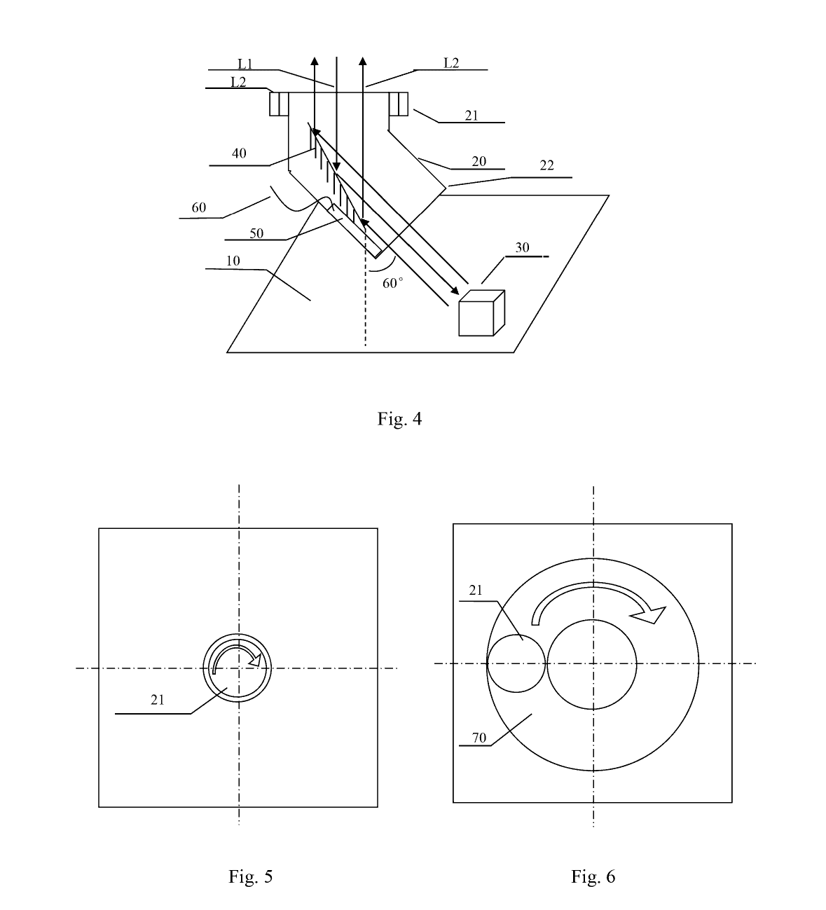

FIG. 3 shows a microscope system according to another specific embodiment of the present disclosure, FIG. 4 shows a microscope system according to a further specific embodiment of the present disclosure, and they are approximately the same as the microscope lens shown in FIG. 2. Compared with the embodiment of the microscope lens shown in FIG. 2, the embodiments shown in FIGS. 3 and 4 differ in that they are further provided with a light source 50, which has an annular configuration and is disposed inside the objective lens end 22. In such a manner, the microscope lens may be used as a whole more easily and intensity of the reflected light may be increased. Further, in the embodiment shown in FIG. 3, the light source 50 may be a LED light source provided with a power source, which may be a sheet shaped battery and/or an annular shaped battery. In the embodiment shown in FIG. 4, the light source 50 may include an optic fiber 60 for introducing external light (not shown), such that light emitted from an external light source can be introduced into the microscope lens. In such a manner, the microscope lens 20 provided in the present disclosure may utilize an existing light source in prior art, or it may be provided with its own light source, such that the microscope lens 20 provided in the present disclosure can be utilized flexibly and intensity of the reflected light can be increased.

Moreover, the present disclosure further provides a microscope system. As shown in FIGS. 2-4, the microscope system includes: an object stage 10 configured for supporting the observed object 30 (such as a glass substrate or other objects); the microscope lens 20 as described above, configured for observing the observed object 30 supported on the object stage 10; and a rotation mechanism for the microscope lens 20, the rotation mechanism being configured for implementing a 360 degree rotation movement of the microscope lens 20 relative to the observed object 30 supported on the object stage 10, so as to realize a 360 degree omnidirectional observation on the observed object 30 supported on the object stage 10.

As shown in FIG. 6, the rotation mechanism includes an annular rail 70, on which the microscope lens 20 are movably disposed. Preferably, the microscope lens 20 may be disposed on the annular rail 70 via a gear mechanism (not shown). Of course, the gear mechanism may be replaced by any suitable movement mechanism that can realize a movement of the microscope lens relative to the annular rail. More preferably, the rotation mechanism may further include a driving motor (not shown) for driving the microscope lens 20. Of course, the driving motor may be any driving source that can realize movement of the microscope lens relative to the annular rail, for example, the driving motor may be a micro servo motor.

It is to be noted that, in the microscope system provided in the present disclosure, the 360 degree rotation movement of the microscope lens 20 relative to the observed object 30 supported on the object stage 10 may be achieved through at least three manners as follows. In a first manner, as shown in FIG. 5, the central axis of the eye lens end 21 is served as an axis of rotation of the microscope lens 20, such that the microscope lens 20 rotates about the central axis of the eye lens end 21. In this manner, a position of the objective lens end moves, thus, a suitable conveying mechanism is required to move the observed object 30 such that a movement of the observed object follows the movement of the objective lens end. In order to realize the 360 degree omnidirectional observation on the observed object 30 supported on the object stage 10, the observed object 30 does not rotate during its movement. This can be realized by providing a suitable conveying mechanism (not shown) on the object stage 10. However, the solution in this manner is complicated since a great modification to the object stage is needed. In the first manner, a driving mechanism for rotation movement of the microscope lens may include a driving motor for driving the microscope lens to rotate. In a second manner, as shown in FIG. 6, the microscope system is provided with an annular rail 70 such that the eye lens end 21 of the microscope lens may perform a 360 degree movement around a center (which corresponds to the position where the observed object 30 is placed) of the annular rail 70, and at the same time, the eye lens end 21 of the microscope lens itself rotates, so that the 360 degree omnidirectional observation on the observed object 30 supported on the object stage 10 may be realized. In a third manner, the eye lens end 21 keeps still while the observed object 30 rotates, such that the 360 degree omnidirectional observation on the observed object 30 supported on the object stage 10 may be realized. Rotation of the observed object 30 may be realized by providing a rotation platform on the object stage 10. The third manner can be easily understood, thus, no drawing thereof is provided herein. In the microscope system provided in the present disclosure, the second manner would be optimal.

From the above, in the microscope system provided in the present disclosure, first, a reflector oriented at a certain angle is provided inside the microscope lens to change the light path so as to realize a microscopic stereoscopic observation at the certain angle; second, by providing the light source inside the microscope lens, intensity of light may be increased; third, by providing the rotation mechanism for the microscope lens in the microscope system, a 360 degree omnidirectional observation on an observed object may be realized. Therefore, with the microscope lens and the microscope system provided in the present disclosure, observation and identification of defect(s) on an observed object (for example a glass substrate) can be improved, accuracy of statistic of product yield can be increased, and a significantly adverse influence on subsequent process and apparatus thereof can be avoided.

The above embodiments of the disclosure are to illustratively explain the principle and effect of the present disclosure rather than to limit the present disclosure. It would be appreciated by those skilled in the art that various changes or modifications may be made in these embodiments without departing from the principles and spirit of the disclosure, the scope of which is defined in the claims and their equivalents.

1. A microscope lens, comprising:
an eye lens end; and
an objective lens end,
wherein a central axis of the eye lens end intersects a central axis of the objective lens end; and
wherein the microscope lens further comprises a reflector disposed between the eye lens end and the objective lens end, such that light from one of the eye lens end and the objective lens end is reflected by the reflector before exiting from the other of the eye lens end and the objective lens end.

2. The microscope lens according to claim 1, wherein an inclination angle of the reflector relative to the central axis of the eye lens end is configured to be a half of an included angle between the central axis of the objective lens end and the central axis of the eye lens end.

3. The microscope lens according to claim 1, wherein the reflector is formed separately from the eye lens end and the objective lens end, or the reflector is formed integrally with at least one of the eye lens end and the objective lens end.

4. The microscope lens according to claim 1, further comprising a light source disposed inside the microscope lens, the light source being disposed in an annular configuration along an inner circumference of the objective lens end.

5. The microscope lens according to claim 4, wherein the light source comprises a LED light source provided with a power source.

6. The microscope lens according to claim 5, wherein the power source comprises at least one of a sheet shaped battery and an annular shaped battery.

7. The microscope lens according to claim 1, further comprising an optic fiber for introducing illumination light from an external light source into the microscope lens.

8. A microscope system, comprising:
an object stage configured for supporting an observed object;
the microscope lens according to claim 1, configured for observing the observed object supported on the object stage; and
a rotation mechanism for the microscope lens, the rotation mechanism being configured for implementing a 360 degree rotation movement of the microscope lens relative to the observed object to realize a 360 degree omnidirectional observation on the observed object.

9. The microscope system according to claim 8, wherein the rotation mechanism comprises an annular rail on which the microscope lens is movably disposed.

10. The microscope system according to claim 9, wherein the microscope lens is disposed on the annular rail via a gear mechanism.

11. The microscope system according to claim 9, wherein the rotation mechanism further comprises a driving motor configured for driving the microscope lens.

12. A microscope system, comprising:
an object stage configured for supporting an observed object;
the microscope lens according to claim 1, configured for observing the observed object supported on the object stage;
a driving mechanism for rotational movement of the microscope lens, the driving mechanism being configured to rotate the microscope lens about a central axis of the eye lens end of the microscope lens; and
a conveying mechanism disposed on the object stage and configured to move the observed object following the rotational movement of the microscope lens.

13. The microscope system according to claim 12, wherein the driving mechanism for rotational movement of the microscope lens further comprises a driving motor configured for driving the microscope lens to rotate.

14. The microscope system according to claim 8, wherein an inclination angle of the reflector relative to the central axis of the eye lens end is configured to be a half of an included angle between the central axis of the objective lens end and the central axis of the eye lens end.

15. The microscope system according to claim 8, wherein the reflector is formed separately from the eye lens end and the objective lens end, or the reflector is formed integrally with at least one of the eye lens end and the objective lens end.

16. The microscope system according to claim 8, further comprising a light source disposed inside the microscope lens, the light source being disposed in an annular configuration along an inner circumference of the objective lens end.

17. The microscope system according to claim 8, further comprising an optic fiber for introducing illumination light from an external light source into the microscope lens.

18. The microscope system according to claim 12, wherein an inclination angle of the reflector relative to the central axis of the eye lens end is configured to be a half of an included angle between the central axis of the objective lens end and the central axis of the eye lens end.

19. The microscope system according to claim 12, wherein the reflector is formed separately from the eye lens end and the objective lens end, or the reflector is formed integrally with at least one of the eye lens end and the objective lens end.

20. The microscope system according to claim 12, further comprising a light source disposed inside the microscope lens, the light source being disposed in an annular configuration along an inner circumference of the objective lens end.
